(19) United States
(12) Patent Application Publication
(10) Pub. No.: US 2024/0005594 A1
(43) Pub. Date: Jan. 4, 2024

(54) VIRTUALIZATION OF TANGIBLE OBJECT COMPONENTS

(71) Applicant: Tangible Play, Inc., Palo Alto, CA (US)

(72) Inventors: Vivardhan Kanoria, Mountain View, CA (US); Rohitkrishna Nambiar, Sunnyvale, CA (US); Yueqiu Sun, Mountain View, CA (US); Vivek Vidyasagaran, Raleigh, NC (US)

(21) Appl. No.: 18/247,445

(22) PCT Filed: Sep. 30, 2021
(86) PCT No.: PCT/US2021/053025

§ 371 Date: Mar. 30, 2023

Related U.S. Application Data
(60) Provisional application No. 63/085,851, filed on Sep. 30, 2020.

(51) Int. Cl. G06T 17/00; G06T 7/60; A63F 13/213; A63F 13/655; G06F 3/04815

(52) U.S. Cl. CPC G06T 17/00; G06T 7/60; A63F 13/213; A63F 13/655; G06F 3/04815

(57) ABSTRACT

Various implementations for detection and virtualization of tangible interface object dimensions include a method that includes capturing, using a video capture device associated with a computing device, a video stream of a physical activity scene, the video stream including a first tangible interface object representing a measurement attribute, identifying, using a processor of the computing device, the measurement attribute of the first tangible interface object, determining, using the processor of the computing device, a virtual object represented by the measurement attribute of the first tangible interface object, and displaying, on a display of the computing device, a graphical user interface embodying a virtual scene, the virtual scene including the virtual object.

### BACKGROUND

The present disclosure relates to detection and virtualization of one or more dimensions of one or more tangible interface objects.

A tangible object visualization system uses the visualization system to capture tangible objects and generate virtualizations of the tangible interface objects on an interface within the system. Providing software-driven visualizations associated with the tangible objects allows for the user to interact and play with tangible objects while also realizing the creative benefits of the software visualization system. This can create an immersive experience where the user has both tangible and digital experiences that interact with each other.

In some solutions, objects may be placed near the visualization system and a camera may capture images of the objects for image processing. However, the images captured by the camera for image processing, require the object to be placed in a way that the image processing techniques can recognize the object. Often, when a user is playing with the object, such as when using the visualization system, the object will be obscured by the user or a portion of the user's hand and the movement and placement of the visualization system may result in poor lighting and image capture conditions. As such, significant time and processing must be spent to identify the object and if the image cannot be analyzed because of poor quality or the object being obscured, then a new image must be captured, potentially resulting in losing a portion of an interaction with the object by the user.

Further issues arise in that specific setups of specialized objects in a specific configuration are often required to interact with the objects and the system. For example, an activity surface must be carefully setup to comply with the calibrations of the camera and if the surface is disturbed, such as when it is bumped or moved by a user, the image processing loses referenced calibration points and will not work outside of the constraints of the specific setup. These difficulties in setting up and using the visualization systems, along with the high costs of these specialized system has led to limited adoption of the visualization systems because of the user is not immersed in their interactions with the objects.

### SUMMARY

According to one innovative aspect of the subject matter in this disclosure, a method for detection and virtualization of tangible object dimensions is described. In an example implementation, the method includes displaying, on a display of a computing device, a graphical user interface embodying a virtual scene, the virtual scene including a virtual prompt representing a virtual dimension; capturing, using a video capture device associated with the computing device, a video stream of a physical activity scene, the video stream including a first tangible interface object representing a first measurement attribute and a second tangible interface object representing a second measurement attribute; identifying, using a processor of the computing device, the first measurement attribute of the first tangible interface object; identifying, using the processor of the computing device, the second measurement attribute of the second tangible interface object; determining, using the processor of the computing device, a combined measurement attribute based on the first measurement attribute and the second measurement attribute; comparing, using the processor of the computing device, the combined measurement attribute with the virtual dimension; and displaying, on a display of the computing device, a graphical user interface embodying a virtual scene, the virtual scene including a status indicator based on the comparison between the combined measurement attribute and the virtual dimension. Other embodiments of this aspect include corresponding computer systems, apparatus, and computer programs recorded on one or more computer storage devices, each configured to perform the actions of the methods.

Implementations may include one or more of the following features. The method where the first measurement attribute is identified by detecting a first dimensional marking on the first tangible interface object and the second measurement attribute is identified by detecting a second dimensional marking on the second tangible interface object. The comparison between the combined measurement attribute and the virtual dimension is one of the combined measurement attribute being greater than the virtual dimension, the combined measurement attribute being less than the virtual dimension, and the combined measurement attribute being equivalent to the virtual dimension. The first measurement attribute is a first dimensional length of the first tangible interface object and the second measurement attribute is a second dimensional length of the second tangible interface object. The virtual dimension is based on a physical character measurement attribute of a physical character in the physical activity scene. Implementations of the described techniques may include hardware, a method or process, or computer software on a computer-accessible medium.

One general aspect includes a method that includes a video stream of a physical activity scene, the video stream including a first tangible interface object representing a measurement attribute; identifying, using a processor of the computing device, the measurement attribute of the first tangible interface object; determining, using the processor of the computing device, a virtual object represented by the measurement attribute of the first tangible interface object; and displaying, on a display of the computing device, a graphical user interface embodying a virtual scene, the virtual scene including the virtual object. Other embodiments of this aspect include corresponding computer systems, apparatus, and computer programs recorded on one or more computer storage devices, each configured to perform the actions of the methods.

Implementations may include one or more of the following features. The method where the first tangible interface object includes one or more visual elements displayed on a surface of the first tangible interface object, the one or more visual elements being detectable by the processor of the computing device. The one or more visual elements of the first tangible interface object includes a dimensional marking. The video stream further includes a physical character in the physical activity scene, the physical character having a physical character attribute, the method may include: comparing the measurement attribute of the first tangible interface object with the physical character attribute; and responsive to determining that the measurement attribute of the first tangible interface object is equivalent to the physical character attribute, updating on the display of the computing device, the virtual scene to include a status update indicating that the measurement attribute of the first tangible interface object is equivalent to the physical character attribute. The method may include: displaying, on the display of the computing device, a virtual prompt representing a virtual measurement attribute; and comparing the measurement attribute of the first tangible interface object to the virtual measurement attribute. The method may include: responsive to the comparison indicating that the measurement attribute of the first tangible interface object is equivalent to the virtual measurement attribute, executing a virtual routine in the virtual scene indicating that the comparison was correct. The method may include: responsive to the comparison indicating that the measurement attribute of the first tangible interface object is not equivalent to the virtual measurement attribute, executing a virtual routine in the virtual scene indicating that the comparison was incorrect. The video stream is a first video stream, and the measurement attribute is a first measurement attribute, the method may include: capturing, using the video capture device associated with the computing device, a second video stream of the physical activity scene, the second video stream including the first tangible interface object representing the first measurement attribute and a second tangible interface object representing a second measurement attribute; identifying, using the processor of the computing device, the second measurement attribute of the second tangible interface object; grouping, using the processor of the computing device, the first measurement attribute with the second measurement attribute to determine a combined measurement attribute of the first tangible interface object and the second tangible interface object; and comparing the combined measurement attribute with a virtual dimension to determine if the combined measurement attribute is equivalent to the virtual dimension. Implementations of the described techniques may include hardware, a method or process, or computer software on a computer-accessible medium.

The physical activity visualization system also includes a video capture device coupled for communication with a computing device, the video capture device being adapted to capture a video stream that includes a first tangible interface object representing a measurement attribute; a detector coupled to the computing device, the detector being adapted to identify within the video stream the measurement attribute of the first tangible interface object; a processor of the computing device, the processor being adapted to determine a virtual object represented by the measurement attribute of the first tangible interface object; and a display coupled to the computing device, the display being adapted to display a graphical user interface embodying a virtual scene, the virtual scene including the virtual object. Other embodiments of this aspect include corresponding computer systems, apparatus, and computer programs recorded on one or more computer storage devices, each configured to perform the actions of the methods.

Implementations may include one or more of the following features. The physical activity visualization system where the first tangible interface object includes one or more visual elements displayed on a surface of the first tangible interface object, the one or more visual elements being detectable by the processor of the computing device. The one or more visual elements of the first tangible interface object includes a dimensional marking. The video stream further includes a physical character, the physical character having a physical character attribute, and the processor being further adapted to compare the measurement attribute of the first tangible interface object with the physical character attribute, and responsive to determining that the measurement attribute of the first tangible interface object is equal to the physical character attribute, update on the display of the computing device, the virtual scene to include a status update indicating that the measurement attribute of the first tangible interface object is equivalent to the physical character attribute. The display is further adapted to display a virtual prompt representing a virtual dimension and the processor is further adapted to compare the measurement attribute of the first tangible interface object to the virtual dimension. Responsive to the comparison indicating that the measurement attribute of the first tangible interface object is equivalent to the virtual dimension, causing the processor to execute a virtual routine in the virtual scene indicating that the comparison was correct. Responsive to the comparison indicating that the measurement attribute of the first tangible interface object is not equivalent to the virtual dimension, causing the processor to execute a virtual routine in the virtual scene indicating that the comparison was incorrect. The video stream is a first video stream and the measurement attributes a first measurement attribute, and where, the video capture device is further adapted to capture a second video stream, the second video stream including the first tangible interface object representing the first measurement attribute and a second tangible interface object representing a second measurement attribute; and the processor if further adapted to identify the second measurement attribute of the second tangible interface object, group the first measurement attribute with the second measurement attribute to determine a combined measurement attribute of the first tangible interface object and the second tangible interface object, and compare the combined measurement attribute with a virtual dimension to determine if the combined measurement attribute is equal to the virtual dimension. Implementations of the described techniques may include hardware, a method or process, or computer software on a computer-accessible medium.

The method also includes capturing, using a video capture device associated with a computing device, a video stream of a physical activity scene, the video stream including a first tangible interface object with a first quantity attribute marking and a second tangible interface object with a second quantity attribute marking; identifying, using a processor of the computing device, the first quantity attribute marking of the first tangible interface object; identifying, using a processor of the computing device, the second quantity attribute marking of the second tangible interface object; determining, using the processor of the computing device, a combined quantity based on the first quantity attribute marking and the second quantity attribute marking; generating, using the processor of the computing device, a virtual quantity object based on the combined quantity; and displaying, on a display of the computing device, a graphical user interface embodying a virtual scene, the virtual scene including the virtual quantity object. Other embodiments of this aspect include corresponding computer systems, apparatus, and computer programs recorded on one or more computer storage devices, each configured to perform the actions of the methods.

Implementations may include one or more of the following features. The method where the first tangible interface object is a cube and the first quantity attribute marking is a rectangular square visible on the cube. The second tangible interface object is a rod and the second quantity attribute marking is a plurality of rectangular square visible on the rod.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1A-1C are an example configuration for detection and virtualization of tangible object dimensions.

FIG. 2 is a block diagram illustrating an example computer system for detection and virtualization of tangible object dimensions.

FIG. 3 is a block diagram illustrating an example computing device.

FIG. 4 is an example configuration for detection and virtualization of tangible object dimensions.

FIG. 5 is an example configuration for detection and virtualization of tangible object quantities.

FIGS. 6A and 6B are example configurations for detection and virtualization of tangible object quantities.

FIG. 7 is a flowchart for detection and virtualization of tangible object dimensions.

FIG. 8 is a flowchart detection and virtualization of tangible object quantities.

### DETAILED DESCRIPTION

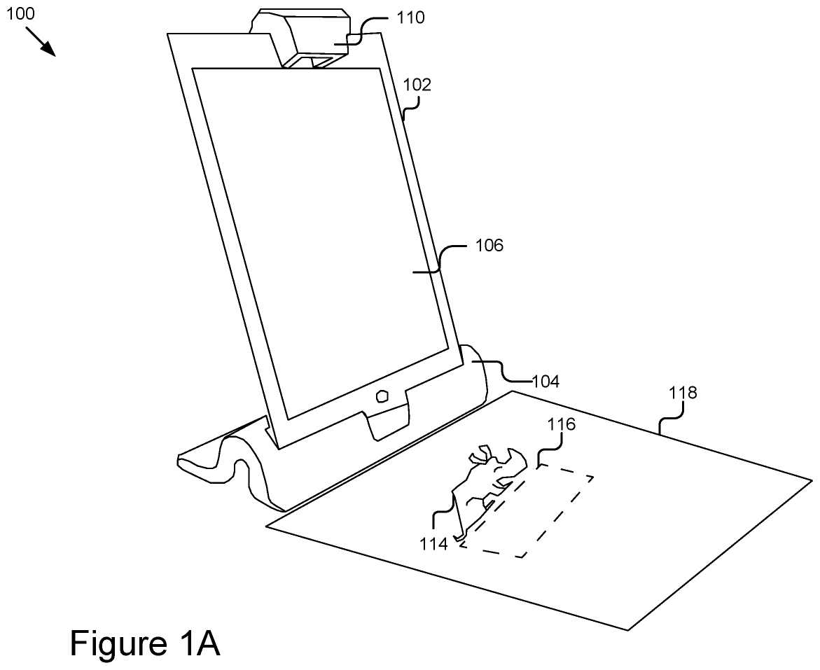

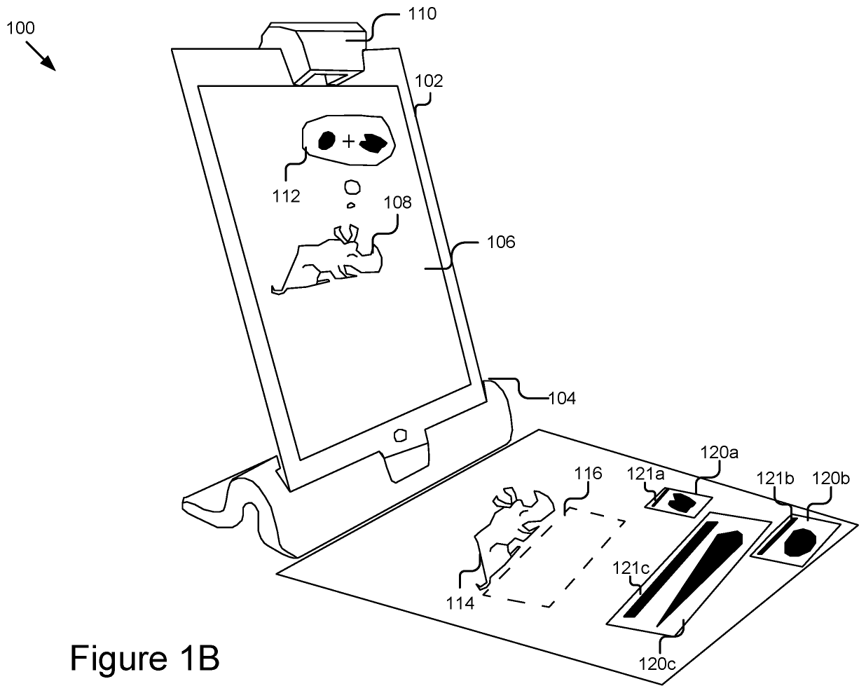

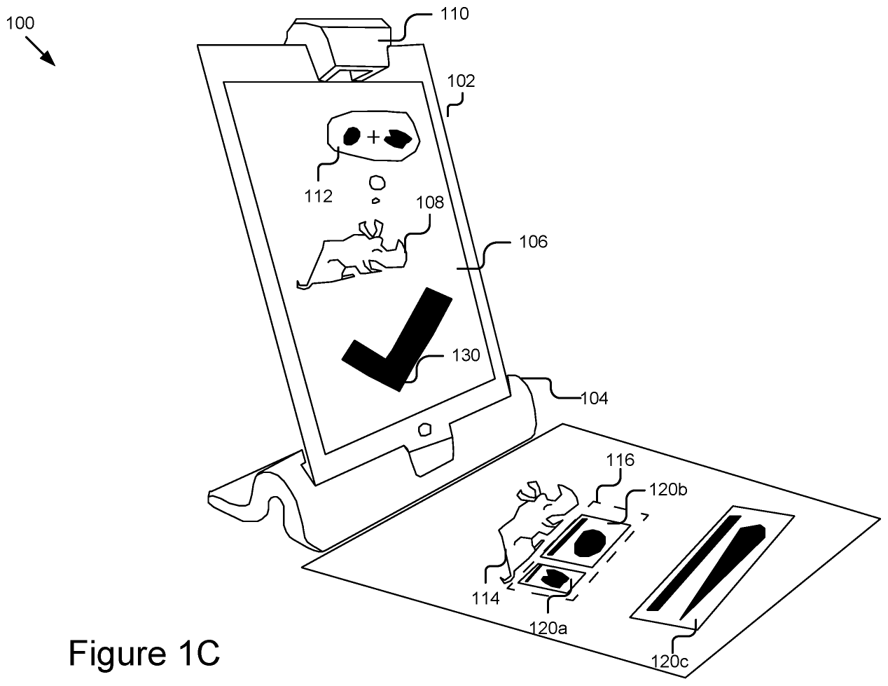

FIGS. 1A-1C are an example configuration 100 for detection and virtualization of tangible interface object 120 dimensions on a physical activity surface 118. As depicted, the configuration 100 includes, in part, a tangible, physical activity surface 118, on which tangible interface objects 120 may be positioned (e.g., placed, drawn, created, molded, built, projected, etc.) and a computing device 102 that is equipped or otherwise coupled to a video capture device, which in some implementations may be coupled to an adapter 110 configured to capture video of the physical activity surface 118. The computing device 102 includes novel software and/or hardware capable of displaying a virtual scene 106 including in some implementations a virtual character 108, and/or other virtual elements.

While the physical activity surface 118 on which the platform is situated is depicted as substantially horizontal in FIG. 1, it should be understood that the physical activity surface 118 can be vertical or positioned at any other angle suitable to the user for interaction. The physical activity surface 118 can have any color, pattern, texture, and topography. For instance, the physical activity surface 118 can be substantially flat or be disjointed/discontinuous in nature. Non-limiting examples of an activity surface include a table, desk, counter, ground, a wall, a whiteboard, a chalkboard, a customized surface, a user's lap, etc. In further implementations, the physical activity surface 118 may be configured for creating and/or drawing, such as a notepad, whiteboard, or drawing board.

As shown in FIG. 1B, in some implementations, the physical activity surface 118 may be preconfigured for use with a tangible interface object 120, such as tangible interface objects 120a, 120b, and/or 120c. While in further implementations, the activity surface may be any surface on which the tangible interface object 120 may be positioned. While the tangible interface object 120 is presented as a substantially flat object that may be placed on the physical activity surface 118, the tangible interface object 120 may be any object that can be physically manipulated and positioned on the physical activity surface 118.

In some implementations, specific examples of the tangible interface object 120, as shown by examples 120a-120c may include different measurement attributes. These measurement attributes may represent different dimensional lengths representing different horizontal lengths, vertical lengths, or other dimensions. In some implementations, the measurement attributes may represent a quantity attribute or quantity value. In some implementations, the measurement attribute may represent some other measurement, such as an area, a circumference, a diameter, a rotation, an angle, etc. In some examples, such as shown in FIG. 1B, the different tangible interface objects 120a-120c may include visual elements displayed on the surface of the tangible interface objects 120a-120c. In one example, these visual elements may be cardboard cutouts visualizing common items, such as a shape or a piece of food, etc. In some implementations, the visual elements may include a dimensional markings 121, such as a horizontal bar 121a-121c representing a dimensional length as shown in FIG. 1B.

In some implementations, the dimensional markings 121 may be visual aspects of the tangible interface object 120 that are detectable by a detection engine 212 to determine a dimensional length value of the tangible interface object 120. For example, in some implementations, the dimensional markings 121 may represent a ruler with small lines denoting different measurement units. In further implementations, the dimensional markings 121 may be incorporated into the presentation of the visual elements of the tangible interface object 120 to not distract a user as they manipulate the tangible interface object 120. In these implementations, the dimensional markings 121 may be detectable by the detection engine 212, such as by having differing colors or outlines than other elements in the visual markings. The detection engine 212 may be configured to detect one or more features of the tangible interface object 120, such as the visual elements and/or the one or the dimensional markings 121 and identify the specific tangible interface object 120 and/or a dimensional value of the tangible interface object 120 using those features.

In some implementations, the activity surface may include (or be formed by) a sheet or workbook that depicts a physical character 114. In some implementations, the physical activity surface may include a portion of the physical activity surface 118, such as a corner or side, with one or more visual markings that are identifiable by the computing device 102 to determine the identity of that physical activity surface 118 configuration. The physical character 114 may signal to the user what type of activity is represented by the specific sheet or workbook present on the physical activity surface 118. In some implementations, a detector 304 may be configured to detect the physical character 114 and/or other visual markings or indicators on the physical activity surface 118 and execute a virtual routine to display an animated character 108 that is similar to the physical character 114. In further implementations, the physical character 114 may be something other than a character, such as a shape, prompt, input, text, or other object depicted on or in the physical activity surface 118. In some implementations, the physical character 114 may have a specific dimensional length that can be used in a length activity with the animated character and the virtual routine. The specific dimensional length of the physical character may be one or more of a horizontal dimensional length, a vertical dimensional length, or other dimensional length of the entire, or a portion, of the physical character 114.

Proximate or near to the physical character on the activity surface, an input area 116 may be included where one or more tangible interface objects 120 may be positioned. In some implementations, the detection engine 212 may be configured to only look for and identify tangible interface objects 120 and/or features positioned in the input area 116 in order to speed up processing and recognition time for different tangible interface objects 120 and/or the interactions with a user and the tangible interface objects 120 in the input area 116. It should be understood that the detection engine 212 is also capable of detecting tangible interface objects 120 and/or other elements anywhere within the field of view of the video capture device. In some implementations, the input area 116 may include a border and/or other indicator along the edges of the input area 116. The border and/or other indicator may be visible to a user and may be detectable by the computing device 102 to bound the edges of the physical activity surface 118 within the field-of-view of the camera. In further implementations, the input area 116 boundaries may be incorporated into the sheet or workbook page and unrecognizable to the user, while still being detectable by the detection engine 212.

In some implementations, the physical activity surface 118 may be integrated with a stand 104 that supports the computing device 102 or may be distinct from the stand 104 but placeable adjacent to the stand 104. In some instances, the size of the interactive area on the physical activity surface 118 may be bounded by the field of view of the video capture device and can be adapted by an adapter 110 and/or by adjusting the position of the video capture device. In additional examples, the boundary and/or other indicator may be a light projection (e.g., pattern, context, shapes, etc.) projected onto the activity surface 118.

In some implementations, the computing device 102 included in the example configuration 100 may be situated on the surface or otherwise proximate to the surface. The computing device 102 can provide the user(s) with a virtual portal for displaying the virtual scene 106. For example, the computing device 102 may be placed on a table in front of a user 210 (not shown) so the user 210 can easily see the computing device 102 while interacting with the tangible interface object 120 on the physical activity surface 118. Example computing devices 102 may include, but are not limited to, mobile phones (e.g., feature phones, smart phones, etc.), tablets, laptops, desktops, netbooks, TVs, set-top boxes, media streaming devices, portable media players, navigation devices, personal digital assistants, personal video game devices, etc.

The computing device 102 includes or is otherwise coupled (e.g., via a wireless or wired connection) to a video capture device 206 (also referred to herein as a camera) for capturing a video stream of the physical activity scene. As depicted in FIG. 1 the video capture device 206 (not shown) may be a front-facing camera that is equipped with an adapter 110 that adapts the field of view of the camera 206 to include, at least in part, the physical activity surface 118. For clarity, the physical activity scene of the physical activity surface 118 captured by the video capture device 110 is also interchangeably referred to herein as the activity surface or the activity scene in some implementations.

As depicted in FIG. 1, the computing device 102 and/or the video capture device 110 may be positioned and/or supported by a stand 104. For instance, the stand 104 may position the display of the computing device 102 in a position that is optimal for viewing and interaction by the user who may be simultaneously positioning the tangible interface object 120 and/or interacting with the physical environment. The stand 104 may be configured to rest on the activity surface (e.g., table, desk, etc.) and receive and sturdily hold the computing device 102 so the computing device 102 remains still during use.

In some implementations, the tangible interface object 120 may be used with a computing device 102 that is not positioned in a stand 104 and/or using an adapter 110. The user 210 may position and/or hold the computing device 102 such that a front facing camera or a rear facing camera may capture the tangible interface object 120 and then a virtual scene 106 may be presented on the display of the computing device 102 based on the capture of the tangible interface object 120.

In some implementations, the adapter 110 adapts a video capture device 110 (e.g., front-facing, rear-facing camera) of the computing device 102 to capture substantially only the physical activity surface 118, although numerous further implementations are also possible and contemplated. For instance, the camera adapter 110 can split the field of view of the front-facing camera into two scenes. In this example with two scenes, the video capture device 110 captures a physical activity scene that includes a portion of the activity surface and is able to capture a tangible interface object 120 in either portion of the physical activity scene. In another example, the camera adapter 110 can redirect a rear-facing camera of the computing device (not shown) toward a front-side of the computing device 102 to capture the physical activity scene of the activity surface located in front of the computing device 102. In some implementations, the adapter 110 can define one or more sides of the scene being captured (e.g., top, left, right, with bottom open). In some implementations, the camera adapter 110 can split the field of view of the front facing camera to capture both the physical activity scene and the view of the user interacting with the tangible interface object 120. In some implementations, if the user consents to a recording of this split view for privacy concerns, a supervisor (e.g., parent, teacher, etc.) can monitor a user 210 positioning the tangible interface object 120 and provide comments and assistance in real-time.

In some implementations, the adapter 110 and stand 104 for a computing device 102 may include a slot for retaining (e.g., receiving, securing, gripping, etc.) an edge of the computing device 102 to cover at least a portion of the camera 206. The adapter 110 may include at least one optical element (e.g., a mirror) to direct the field of view of the camera 206 toward the activity surface. The computing device 102 may be placed in and received by a compatibly sized slot formed in a top side of the stand 104. The slot may extend at least partially downward into a main body of the stand 104 at an angle so that when the computing device 102 is secured in the slot, it is angled back for convenient viewing and utilization by its user or users. The stand 104 may include a channel formed perpendicular to and intersecting with the slot. The channel may be configured to receive and secure the adapter 110 when not in use. For example, in some implementations, the adapter 110 may have a tapered shape that is compatible with and configured to be easily placeable in the channel of the stand 104. In some instances, the channel may magnetically secure the adapter 110 in place to prevent the adapter 110 from being easily jarred out of the channel. The stand 104 may be elongated along a horizontal axis to prevent the computing device 102 from tipping over when resting on a substantially horizontal activity surface (e.g., a table). The stand 104 may include channeling for a cable that plugs into the computing device 102. The cable may be configured to provide power to the computing device 102 and/or may serve as a communication link to other computing devices, such as a laptop or other personal computer.

In some implementations, the adapter 110 may include one or more optical elements, such as mirrors and/or lenses, to adapt the standard field of view of the video capture device 110. For instance, the adapter 110 may include one or more mirrors and lenses to redirect and/or modify the light being reflected from activity surface into the video capture device 110. As an example, the adapter 110 may include a mirror angled to redirect the light reflected from the activity surface in front of the computing device 102 into a front-facing camera of the computing device 102. As a further example, many wireless handheld devices include a front-facing camera with a fixed line of sight with respect to the display of the computing device 102. The adapter 110 can be detachably connected to the device over the camera 206 to augment the line of sight of the camera 206 so it can capture the activity surface (e.g., surface of a table, etc.). The mirrors and/or lenses in some implementations can be polished or laser quality glass. In other examples, the mirrors and/or lenses may include a first surface that is a reflective element. The first surface can be a coating/thin film capable of redirecting light without having to pass through the glass of a mirror and/or lens. In an alternative example, a first surface of the mirrors and/or lenses may be a coating/thin film and a second surface may be a reflective element. In this example, the lights passes through the coating twice, however since the coating is extremely thin relative to the glass, the distortive effect is reduced in comparison to a conventional mirror. This mirror reduces the distortive effect of a conventional mirror in a cost-effective way.

In another example, the adapter 110 may include a series of optical elements (e.g., mirrors) that wrap light reflected off of the activity surface located in front of the computing device 102 into a rear-facing camera of the computing device 102 so it can be captured. The adapter 110 could also adapt a portion of the field of view of the video capture device (e.g., the front-facing camera) and leave a remaining portion of the field of view unaltered so that multiple scenes may be captured by the video capture device. The adapter 110 could also include optical element(s) that are configured to provide different effects, such as enabling the video capture device to capture a greater portion of the activity surface. For example, the adapter 110 may include a convex mirror that provides a fisheye effect to capture a larger portion of the activity surface than would otherwise be capturable by a standard configuration of the video capture device 110.

The video capture device 206 could, in some implementations, be an independent unit that is distinct from the computing device 102 and may be positionable to capture the activity surface or may be adapted by the adapter 110 to capture the physical activity surface 118 as discussed above. In these implementations, the video capture device 206 may be communicatively coupled via a wired or wireless connection to the computing device 102 to provide it with the video stream being captured.

As shown in FIG. 1B, a virtual prompt 112 may be displayed on a display of the computing device 102. The virtual prompt 112 may be a specific request for a user to perform. In this example, the virtual character 108 appears to be requesting different objects as shown in the virtual prompt 112. A user may place corresponding tangible interface objects 120 in the input area 116 based on the virtual prompt 112. In some implementations, the virtual prompt 112 may be part of a virtual routine (e.g., a game that a user is interacting with) and the virtual prompt 112 may be a task for the user to perform using the tangible interface objects 120. In some implementations, the virtual prompt 112 may have an intended goal of educating or teaching a user about an element of understanding dimensional lengths using the tangible interface objects and the dimensional markings.

In some implementations, the virtual prompt 112 may be displayed in very literal examples, showing a user which tangible interface objects 120 are being requesting. For example, the virtual prompt 112 may display a virtual dimension on the display screen and then display virtualizations of the dimensional lengths of one or more tangible interface objects 120 detected in the input area 116. In further implementations, the virtual prompt 112 may be less direct, such as to encourage experimentation by the user. For example, the virtual prompt 112 can be a request to “figure out what kind of food the dragon likes” and the tangible interface objects 120 represent different types of food with different dimensional markings representing different dimensional lengths. A user can then position various tangible interface objects 120a-120c within the input area 116 to identify what the dragon (e.g., physical character 114) likes to eat.

As shown in FIG. 1C, when the tangible interface objects 120a and 120b are placed in the input area 116, the activity application(s) 214 determine if the combination of the tangible interface objects 120a and 120b satisfy a dimensional quantity based on the virtual prompt 112. If the activity application(s) 214 determines that the combination of tangible interface objects 120a and 120b satisfy the dimensional quantity based on the virtual prompt 112 then a status update 130 is displayed showing to the user that the virtual prompt 112 was correctly answered. In further implementations, if the combination of the tangible interface objects and/or incorrect dimensional markings are detected, then a different status update 130 may be presented that encourages the user to try again with different tangible interface objects 120. In some implementations, the virtual prompt 112 may be related to a specific dimensional length associated with one or more of a dimensional quantity based on the virtual prompt 112 and/or a length of the physical character 114. For example, the virtual prompt 112 for different shapes may require the user to determine how many tangible interface objects 120 may fit within a length associated with the physical character 114, referred to herein as the physical character attribute or physical character length. For example, a single tangible interface object 120b and a tangible interface objects 120a may fit within a dimensional length threshold represented by the physical character 114, whereas the tangible interface object 120c is too long in dimensional length to satisfy specific dimensional length associated with the physical character 114. The activity application(s) 214 may determine if the grouping of tangible interface objects 120 is equal to, less than, or greater than the physical character length and display a correctness indicator based on the comparison. This process of placing different tangible interface objects 120 within an input area 116 to respond to virtual prompts 112 for various dimensional lengths teaches a user how different lengths can interact with each other. However, by incorporating a computing device 102 that is capturing the placement of tangible interface objects 120 in real-time, an activity application 214 can provide instructions and/or guidance to a user in real-time to simulate an instructor helping a student understand the various dimensional lengths.

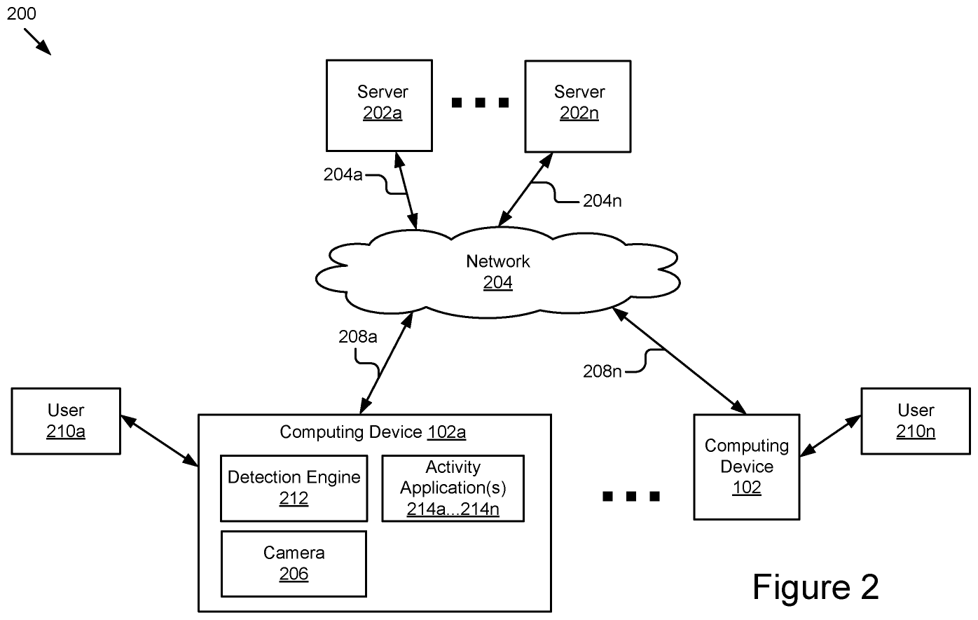

FIG. 2 is a block diagram illustrating an example computer system 200 for detecting and virtualization of tangible object dimensions. The illustrated system 200 includes computing devices 102a . . . 102n (also referred to individually and collectively as 102) and servers 202a . . . 202n (also referred to individually and collectively as 202), which are communicatively coupled via a network 204 for interaction with one another. For example, the computing devices 102a . . . 102n may be respectively coupled to the network 204 via signal lines 208a . . . 208n and may be accessed by users 210a . . . 210n (also referred to individually and collectively as 210). The servers 202a . . . 202n may be coupled to the network 204 via signal lines 204a . . . 204n, respectively. The use of the nomenclature “a” and “n” in the reference numbers indicates that any number of those elements having that nomenclature may be included in the system 200.

The network 204 may include any number of networks and/or network types. For example, the network 204 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing devices 102a . . . 102n (also referred to individually and collectively as 102) are computing devices having data processing and communication capabilities. For instance, a computing device 102 may include a processor (e.g., virtual, physical, etc.), a memory, a power source, a network interface, and/or other software and/or hardware components, such as front and/or rear facing cameras, display, graphics processor, wireless transceivers, keyboard, camera, sensors, firmware, operating systems, drivers, various physical connection interfaces (e.g., USB, HDMI, etc.). The computing devices 102a . . . 102n may couple to and communicate with one another and the other entities of the system 200 via the network 204 using a wireless and/or wired connection. While two or more computing devices 102 are depicted in FIG. 2, the system 200 may include any number of computing devices 102. In addition, the computing devices 102a . . . 102n may be the same or different types of computing devices.

As depicted in FIG. 2, one or more of the computing devices 102a . . . 102n may include a camera 206, a detection engine 212, and activity application(s) 214. One or more of the computing devices 102 and/or cameras 206 may also be equipped with an adapter 110 as discussed elsewhere herein. The detection engine 212 is capable of detecting and/or recognizing the tangible interface object 120 and/or visual elements such as the dimensional markings 121 or other dimensions associated with the tangible interface object 120. The detection engine 212 can detect the position and orientation of each of the tangible interface object(s) 120, detect how the tangible interface object 120 is manipulated by the user 210, and cooperate with the activity application(s) 214 to provide users 210 with a rich virtual experience by detecting the tangible interface object 120 and generating a virtualization in the virtual scene 106 based on the identity, placement, and/or positioning of the tangible interface object 120.

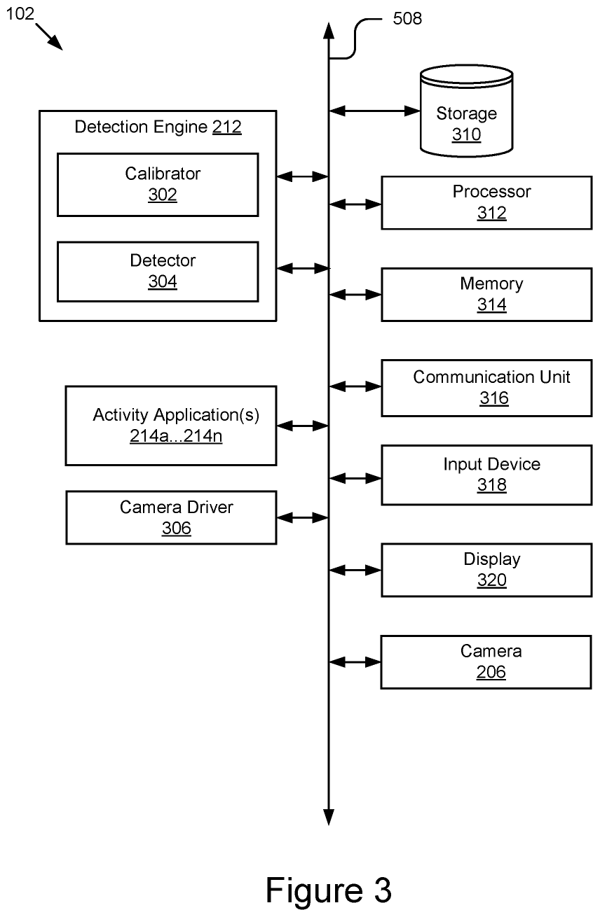

In some implementations, the detection engine 212 processes video captured by a camera 206 to detect visual markers, visual elements, and/or other identifying elements or characteristics of the tangible interface object(s) 120 in order to identify the tangible interface objects 120 and/or the dimensional markings of the tangible interface objects 120. The activity application(s) 214 are capable of determining an identity of the tangible interface object 120 and generating a virtualization or executing a routine to display specific animations in the virtual scene. Additional structure and functionality of the computing devices 102 are described in further detail below with reference to at least FIG. 3.

The servers 202 may each include one or more computing devices having data processing, storing, and communication capabilities. For example, the servers 202 may include one or more hardware servers, server arrays, storage devices and/or systems, etc., and/or may be centralized or distributed/cloud-based. In some implementations, the servers 202 may include one or more virtual servers, which operate in a host server environment and access the physical hardware of the host server including, for example, a processor, memory, storage, network interfaces, etc., via an abstraction layer (e.g., a virtual machine manager).

The servers 202 may include software applications operable by one or more computer processors of the servers 202 to provide various computing functionalities, services, and/or resources, and to send data to and receive data from the computing devices 102. For example, the software applications may provide functionality for internet searching; social networking; web-based email; blogging; micro-blogging; photo management; video, music and multimedia hosting, distribution, and sharing; business services; news and media distribution; user account management; or any combination of the foregoing services. It should be understood that the servers 202 are not limited to providing the above-noted services and may include other network-accessible services.

It should be understood that the system 200 illustrated in FIG. 2 is provided by way of example, and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system 200 may be integrated into a single computing device or system or additional computing devices or systems, etc.

FIG. 3 is a block diagram of an example computing device 102. As depicted, the computing device 102 may include a processor 312, memory 314, communication unit 316, display 320, camera 206, and an input device 318, which are communicatively coupled by a communications bus 308. However, it should be understood that the computing device 102 is not limited to such and may include other elements, including, for example, those discussed with reference to the computing devices 102.

The processor 312 may execute software instructions by performing various input/output, logical, and/or mathematical operations. The processor 312 has various computing architectures to process data signals including, for example, a complex instruction set computer (CISC) architecture, a reduced instruction set computer (RISC) architecture, and/or an architecture implementing a combination of instruction sets. The processor 312 may be physical and/or virtual, and may include a single core or plurality of processing units and/or cores.

The memory 314 is a non-transitory computer-readable medium that is configured to store and provide access to data to the other elements of the computing device 102. In some implementations, the memory 314 may store instructions and/or data that may be executed by the processor 312. For example, the memory 314 may store the detection engine 212, the activity application(s) 214, and the camera driver 306. The memory 314 is also capable of storing other instructions and data, including, for example, an operating system, hardware drivers, other software applications, data, etc. The memory 314 may be coupled to the bus 308 for communication with the processor 312 and the other elements of the computing device 102.

The communication unit 316 may include one or more interface devices (I/F) for wired and/or wireless connectivity with the network 204 and/or other devices. In some implementations, the communication unit 316 may include transceivers for sending and receiving wireless signals. For instance, the communication unit 316 may include radio transceivers for communication with the network 206 and for communication with nearby devices using close-proximity (e.g., Bluetooth®, NFC, etc.) connectivity. In some implementations, the communication unit 316 may include ports for wired connectivity with other devices. For example, the communication unit 316 may include a CAT-5 interface, Thunderbolt™ interface, FireWire™ interface, USB interface, etc.

The display 320 may display electronic images and data output by the computing device 102 for presentation to a user 210. The display 320 may include any conventional display device, monitor or screen, including, for example, an organic light-emitting diode (OLED) display, a liquid crystal display (LCD), etc. In some implementations, the display 320 may be a touch-screen display capable of receiving input from one or more fingers of a user 210. For example, the display 320 may be a capacitive touch-screen display capable of detecting and interpreting multiple points of contact with the display surface. In some implementations, the computing device 102 may include a graphics adapter (not shown) for rendering and outputting the images and data for presentation on display 320. The graphics adapter (not shown) may be a separate processing device including a separate processor and memory (not shown) or may be integrated with the processor 312 and memory 314.

The input device 318 may include any device for inputting information into the computing device 102. In some implementations, the input device 318 may include one or more peripheral devices. For example, the input device 318 may include a keyboard (e.g., a QWERTY keyboard), a pointing device (e.g., a mouse or touchpad), microphone, a camera, etc. In some implementations, the input device 318 may include a touch-screen display capable of receiving input from the one or more fingers of the user 210. For instance, the functionality of the input device 318 and the display 320 may be integrated, and a user 210 of the computing device 102 may interact with the computing device 102 by contacting a surface of the display 320 using one or more fingers. In this example, the user 210 could interact with an emulated (i.e., virtual or soft) keyboard displayed on the touch-screen display 320 by using fingers to contact the display 320 in the keyboard regions.

The detection engine 212 may include a detector 304. The elements 212 and 304 may be communicatively coupled by the bus 308 and/or the processor 312 to one another and/or the other elements 214, 306, 310, 314, 316, 318, 320, and/or 110 of the computing device 102. In some implementations, one or more of the elements 212 and 304 are sets of instructions executable by the processor 312 to provide their functionality. In some implementations, one or more of the elements 212 and 304 are stored in the memory 314 of the computing device 102 and are accessible and executable by the processor 312 to provide their functionality. In any of the foregoing implementations, these components 212, and 304 may be adapted for cooperation and communication with the processor 312 and other elements of the computing device 102.

The detector 304 includes software and/or logic for processing the video stream captured by the camera 206 to detect and/or identify one or more tangible interface object(s) 120 included in the video stream. In some implementations, the detector 304 may identify visual markers or other visual elements included in the tangible interface object(s) 120. In some implementations, the visual markers or visual elements may be detectable based on different colors or shapes, such as dark colors on light backgrounds, etc. In some implementations, the detector 304 may infer visual markings or visual elements that are obscured, such as by a user's hand if enough other visual markings or visual elements have been detected in order to satisfy an inference threshold on an identity of a tangible interface object 120. In some implementations, the detector 304 may be coupled to and receive the video stream from the camera 206, the camera driver 306, and/or the memory 314. In some implementations, the detector 304 may process the images of the video stream to determine positional information for the line segments or other contours/shapes related to the tangible interface object(s) 120 and/or formation of a tangible interface object 120 into a combination on the physical activity surface 118 (e.g., location and/or orientation of the line segments in 2D or 3D space) and then analyze characteristics of the line segments included in the video stream to determine the identities and/or additional attributes of the line segments.

In some implementations, the detector 304 may use visual characteristics to recognize custom designed portions of the physical activity surface 118, such as corners, edges, artistic markings, etc. The detector 304 may perform a straight-line detection algorithm and a rigid transformation to account for distortion and/or bends on the physical activity surface 118. In some implementations, the detector 304 may match features of detected line segments or pixel areas to a reference object that may include a depiction of the individual components of the reference object in order to determine the line segments and/or the boundary of the expected objects in the physical activity surface 118. In some implementations, the detector 304 may account for gaps and/or holes in the detected line segments and/or contours and may be configured to generate a mask to fill in the gaps and/or holes.

In some implementations, the detector 304 may recognize the line by identifying its contours. The detector 304 may also identify various attributes of the line, such as colors, contrasting colors, depth, texture, etc. In some implementations, the detector 304 may use the description of the line and the lines attributes to identify a tangible interface object 120 by comparing the description and attributes to a database of virtual objects and identifying the closest matches by comparing recognized tangible interface object(s) 120 to reference components of the virtual objects. In some implementations, the detector 304 may incorporate machine learning algorithms to add additional virtual objects to a database of virtual objects as new tangible interface objects or combinations of tangible interface objects are identified.

The detector 304 may be coupled to the storage 310 via the bus 308 to store, retrieve, and otherwise manipulate data stored therein. For example, the detector 304 may query the storage 310 for data matching any line segments that it has determined are present in the physical activity surface 118. In all of the above descriptions, the detector 304 may send the detected images to the detection engine 212 and the detection engine 212 may perform the above described features.

The detector 304 may be able to process the video stream to detect a placement or manipulation of the tangible interface object 120. In some implementations, the detector 304 may be configured to understand relational aspects between a tangible interface object 120 and determine an interaction based on the relational aspects. For example, the detector 304 may be configured to identify an interaction related to one or more tangible interface object present in the physical activity surface 118 and the activity application(s) 214 may determine a routine based on the relational aspects between the one or more tangible interface object(s) 120 and other elements of the physical activity surface 118.

The activity application(s) 214 include software and/or logic for identifying one or more tangible interface object(s) 120, identifying a combined position of the tangible interface object(s) 120 relative to each other, determine a virtual object or virtual routine based on the tangible interface object(s) 120, generate a virtual object based on the tangible interface object 120, and/or display a virtual object in the virtual scene 106. The activity application(s) 214 may be coupled to the detector 304 via the processor 312 and/or the bus 308 to receive the information.

In some implementations, the activity application(s) 214 may determine the animated character 108, virtual prompt 112, and/or a routine by searching through a database of virtual objects and/or routines that are compatible with the identified combined position of tangible interface object(s) 120 relative to each other and/or the physical character 114, and/or identity of the physical activity surface 118. In some implementations, the activity application(s) 214 may access a database of virtual objects or routines stored in the storage 310 of the computing device 102. In further implementations, the activity application(s) 214 may access a server 202 to search for virtual objects and/or routines. In some implementations, a user 210 may predefine a virtual object and/or routine to include in the database.

In some implementations, the activity application(s) 214 may enhance the virtual scene and/or the virtual object 122 as part of a routine. For example, the activity application(s) 214 may display visual enhancements as part of executing the routine. The visual enhancements may include adding color, extra virtualizations, background scenery, incorporating a virtual object based on a tangible interface object 120 into a shape and/or character, etc. In some implementations, the activity application(s) 214 may prompt the user to select one or more enhancement options, such as a change to color, size, shape, etc. and the activity application(s) 214 may incorporate the selected enhancement options into the virtual object 122 and/or the virtual scene 106.

The camera driver 306 includes software storable in the memory 314 and operable by the processor 312 to control/operate the camera 206. For example, the camera driver 306 is a software driver executable by the processor 312 for signaling the camera 206 to capture and provide a video stream and/or still image, etc. The camera driver 306 is capable of controlling various features of the camera 206 (e.g., flash, aperture, exposure, focal length, etc.). The camera driver 306 may be communicatively coupled to the camera 206 and the other components of the computing device 102 via the bus 308, and these components may interface with the camera driver 306 via the bus 308 to capture video and/or still images using the camera 206.

As discussed elsewhere herein, the camera 206 is a video capture device configured to capture video of at least the activity surface. The camera 206 may be coupled to the bus 308 for communication and interaction with the other elements of the computing device 102. The camera 206 may include a lens for gathering and focusing light, a photo sensor including pixel regions for capturing the focused light and a processor for generating image data based on signals provided by the pixel regions. The photo sensor may be any type of photo sensor including a charge-coupled device (CCD), a complementary metal-oxide-semiconductor (CMOS) sensor, a hybrid CCD/CMOS device, etc. The camera 206 may also include any conventional features such as a flash, a zoom lens, etc. The camera 206 may include a microphone (not shown) for capturing sound or may be coupled to a microphone included in another component of the computing device 102 and/or coupled directly to the bus 308. In some implementations, the processor of the camera 206 may be coupled via the bus 308 to store video and/or still image data in the memory 314 and/or provide the video and/or still image data to other elements of the computing device 102, such as the detection engine 212 and/or activity application(s) 214.

The storage 310 is an information source for storing and providing access to stored data, such as a database of virtual objects, virtual prompts, routines, and/or virtual elements, gallery(ies) of virtual objects that may be displayed on the display 320, user profile information, community developed virtual routines, virtual enhancements, etc., object data, calibration data, and/or any other information generated, stored, and/or retrieved by the activity application(s) 214.

In some implementations, the storage 310 may be included in the memory 314 or another storage device coupled to the bus 308. In some implementations, the storage 310 may be or included in a distributed data store, such as a cloud-based computing and/or data storage system. In some implementations, the storage 310 may include a database management system (DBMS). For example, the DBMS could be a structured query language (SQL) DBMS. For instance, storage 310 may store data in an object-based data store or multi-dimensional tables comprised of rows and columns, and may manipulate, i.e., insert, query, update, and/or delete, data entries stored in the verification data store using programmatic operations (e.g., SQL queries and statements or a similar database manipulation library). Additional characteristics, structure, acts, and functionality of the storage 310 is discussed elsewhere herein.

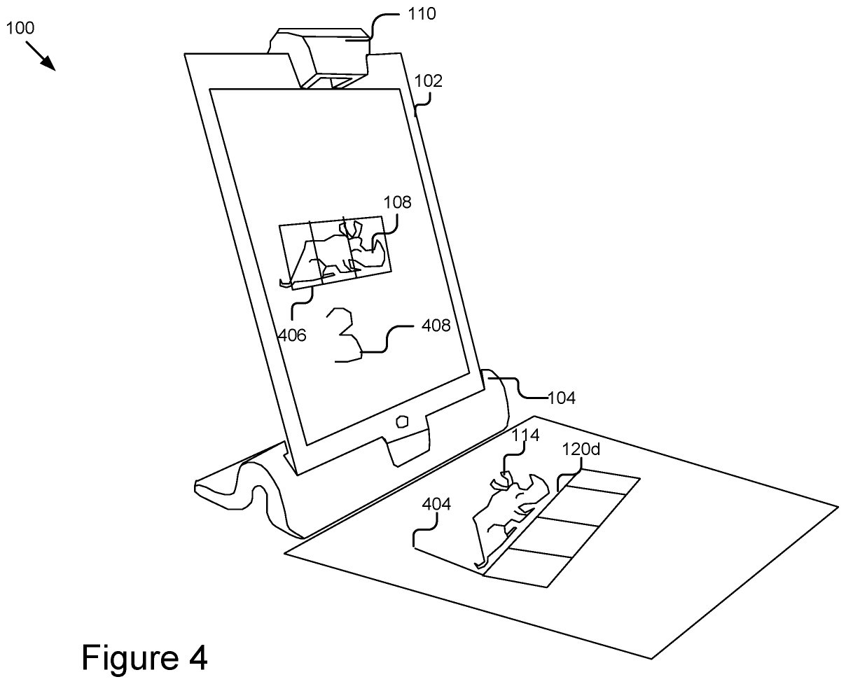

FIG. 4 depicts an example configuration 100 for detection and virtualization of tangible object dimensions. In this example, the tangible interface object 120d is an object that represents a horizontal length dimension, similar to a ruler. In some implementations, the tangible interface object 120d may be formed out of a clear or opaque plastic so that a user can view the contents that would be obscured underneath the tangible interface object 120d. In this example, a virtual character 108 is displayed that is associated with the physical character 114 on the physical activity surface 118. A user can use the tangible interface object 120d to measure the physical character 114. The detector 304 detects the position and/or placement of the tangible interface object 120d as it is being used to measure the physical character 114 and a virtualization of the tangible interface object 120d is displayed as a measuring animation 406 in the virtual scene in substantially real-time. In some implementations, a starting alignment indicator 404 is included in the physical activity surface 118 to signal to the user where to align the tangible interface object 120d. The detection engine 212 may determine if the alignment of the marking of the starting alignment indicator 404 lines up with a specific portion of the tangible interface object 120d and signal to the user if it is correct. If the alignment of the tangible interface object 120d is incorrect, the activity application 214 can determine what type of correction is needed and display an alignment animation on the display screen that signals to the user how to correct the tangible interface object 120d alignment. This real-time alignment process can help young children learn how to measure and align in real-time by providing feedback in real-time that the user can incorporate and view their changes as they adjust an alignment of the tangible interface object 120d and the virtual scene shows a measuring animation 406 is displayed on screen. In some implementations, various tangible interface objects 120 of differing lengths may be included for measuring a length dimension of a variety of physical characters 114 of various lengths.

In some implementations, the virtual scene may include a measurement value 408 that signals to the user the dimension that was measured by the tangible interface object 120d. In some implementations, the tangible interface object 120d may include one or more visual markings (such as the square boxes shown in FIG. 4) that represent quantities for the measurement value. In some implementations, the visual markings may be similar to the line marking on a ruler showing different measurements. In further implementations, other types of visual markings may be used to determine a measurement value 408. The measurement value 408 may be a quantity or other value, such as small, medium, large, etc. In further implementations, the user may provide a measurement value 408, such as by saying it out loud or typing an input after using the tangible interface object 120d. In some implementations, the measurement value 408 may be an animation, such as a piece of cloth or a measuring tape extending out to the measurement value.

In some implementations, finger detection may be used to input a measurement value. For example, the user may align the tangible interface object 120d on or near the physical character 114 and then may place a finger on a specific portion of the tangible interface object 120d or alternatively, slide their finger along the tangible interface object 120d to a point where a measurement length should be determined. The detection engine 212 and activity application 214 may detect the finger placement and determine where the finger placement is relative to the known values of the tangible interface object 120d and display a representation of the determined value based on where the finger placement was detected. In some implementations, the detection engine 212 may use a longest digit determination to identify a hand, and then identify a digit of the hand that is protruding out farther than the other digits, such as a finger pointing while the others are closed into a fist. The detection engine may then determine where an end point of the protruding digit is located relative to other known points, such as known points on the tangible interface object 120d.

In some implementations, the detection engine 212 may account for shifting of the tangible interface object 120d or other tangible interface objects 120 during the measuring process and can either signal to the user if the alignment has changed, or account for the change in alignment and provide feedback based on the updated alignment change. In some implementations, the tangible interface object 120d has different colored blocks, such as black and white, and the detection engine 212 identifies the different colored blocks and using those block detections to determine the units of measurement of the tangible interface object 120d.

In some implementations, a tangible interface object 120d may not be present and instead a user may drag a finger or other portion of a hand along their area where the tangible interface object 120d would be placed to measure the physical character 114. As the finger is dragged/moved across the area, the detection engine displays a visual routine, such as a measuring tape rolling out that mimics the movement of a user's finger moving across the area. This allows a user to mimic measuring the physical character 114 and understand the concept of a length dimension, including a starting and stopping point, without having to physically place a tangible interface object 120d below or over the physical character 114. A measurement value 408 may be shown once a user has successfully dragged a finger or other digit/item across the space representing the length dimension of the physical character 114 from a starting point (for example, a tail of a dragon) to an ending point (for example, a tip of a nose of a dragon).

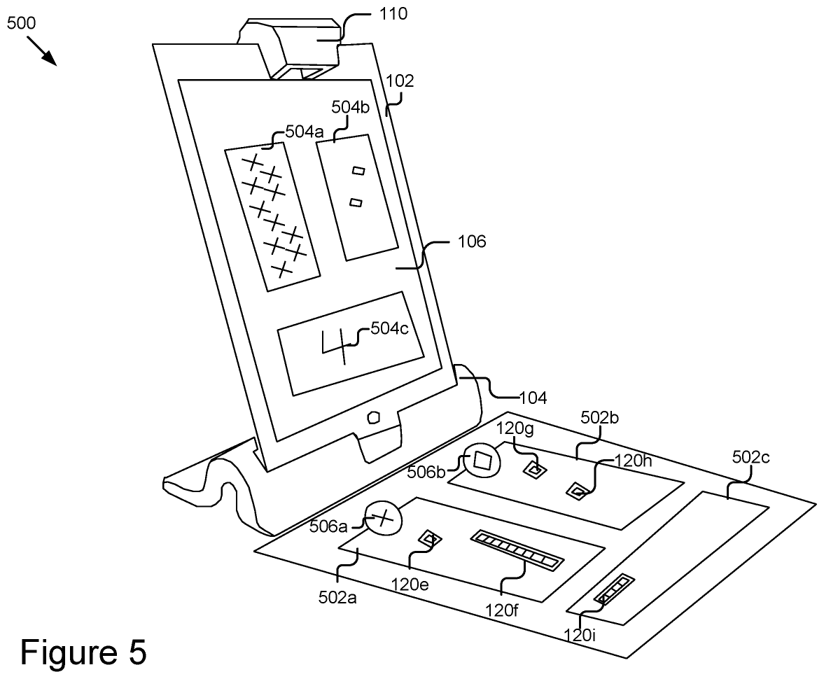

FIG. 5 depicts an example configuration 500 for detection and virtualization of tangible object quantities. As shown in this example configuration 500, the physical activity surface 118 includes a play area with one or more input areas 502 on which tangible interface objects 120 can be placed. In this example, these input areas 502 are represented by rectangular areas 502a, 502b, and 502c, although other shapes of input areas area also contemplated. The input areas 502 are used to change the quantity of virtual objects 504 shown in the virtual scene by placing different quantities of tangible interface objects 120, such as different rods (such as tangible interface object 120f and 120i) and/or cubes (such as tangible interface objects 120e, 120g, and 120h) in the input areas 502a, 502b, and 502c. The tangible interface objects 120e-120i represent various quantities. In some implementations, the tangible interface objects 120e-120i are rods and cubes that depict different amounts of square markings in the rods and cubes that represent the quantity value of each of the rods or cubes. In some implementations, the square markings are an example of a quantity marking that is visible on the tangible interface objects 120. The quantity marking is detectable by the detector 304 and can be used to identify a quantity represented by each of the tangible interface objects 120. For example, the cube 120e has a single square marking denoting a quantity of one, while rod 120f has nine square markings denoting a quantity of nine. It should be understood that while rods and cubes with square markings are shown, any tangible interface objects 120 that can represent a quantity and that are detectable by the detector 304 may be used to represent various quantity values.

The input areas 502 may represent where different quantity groups can be placed to depict different types of virtual objects 504. In some implementations, a type indicator 506 may be displayed on one or more of the input areas and the quantity of tangible interface objects 120 in that area are quantities of the type based on the type indicator 506. In some implementations, a user may place a type indicator 506 in the type indicator area. In further implementations, the play area may include rotating wheels or scroll wheels of types and the type indicator 506 area may be a window to view the exposed portion of the rotating wheel. Using the rotating wheel as a type indicator 506, such as 506a or 506b, the user can quickly rotate the wheel to select the different types for the virtual objects and change the type that the input area is based on. For example, the type indicator 506a may be selecting an “x” while the type indicator 506b may be selecting a “diamond” and the quantities of virtual items for virtual object 504a may correspond to the type selected by type indicator 506a while the quantities of virtual items for virtual object 504b may correspond to the type selected by type indicator 506b.

As shown in the example, the user may place a quantity of tangible interface objects 120 in one or more of the input areas 502 and the detection engine 212 may detect the groups of tangible interface objects 120 in each of the input areas 502 and determine a quantity represented by the groups of tangible interface objects 120 in each input area. The detector 304 may then cause the activity application 214 to execute various routines and/or animations based on the detected quantities in each of the input areas 502. For example, tangible interface objects 120e, 120g, and 120h all represent a single cube with markings representing the unit of one. The tangible interface object 120f is a rod formed out of nine different cubes representing a quantity of nine. The tangible interface object 120i is a rod formed out of four cubes representing the quantity four. The detection engine may detect each of these quantities of rods and cubes and update amounts of those quantities in the virtual scene. As shown, the type indicator 506a depicts an “x” so there are ten “x” icons 504a displayed in the first virtual area to correspond with the quantity ten from the single cube 120 e and the nine rod 120f. The type indicator 506b represents a diamond so the activity application 214 causes two diamonds 504b to be displayed representing the quantity two depicted by the two cubes 120g and 120h. The quantity four is displayed as a numerical number 504c displayed to depict the quantity of the rod 120i.

Using these various detected quantities and types, the user can place multiple objects that are categorized into different types and the detection engine can detect the quantities and types and execute various routines. For example, when a specific quantity of each type is included in the input areas, the activity application(s) 214 may cause an animation to display the combination of the different quantities, such as a potion for a recipe. In further implementations, if the quantities are incorrect, the activity application(s) 214 may cause a corrective action to be displayed to add or remove some of the tangible interface objects 120 and/or change a type input. By providing these corrections, a user can receive real-time feedback and instruction to understand how quantities work using the tangible interface objects 120. In some implementations, one or more virtual prompts may be displayed in the virtual scene to signal to the user the different quantities to place in one or more of the input areas 502.

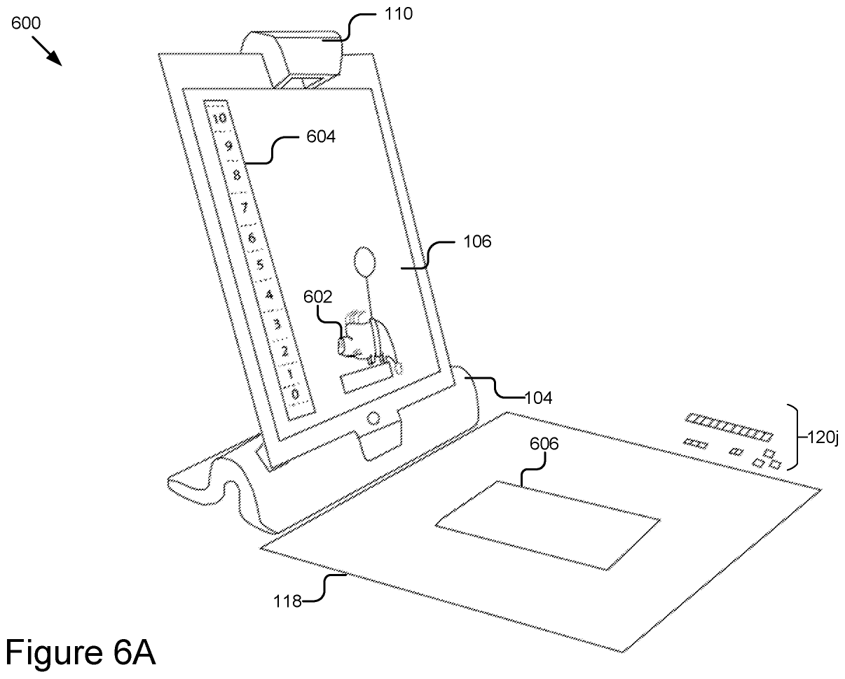

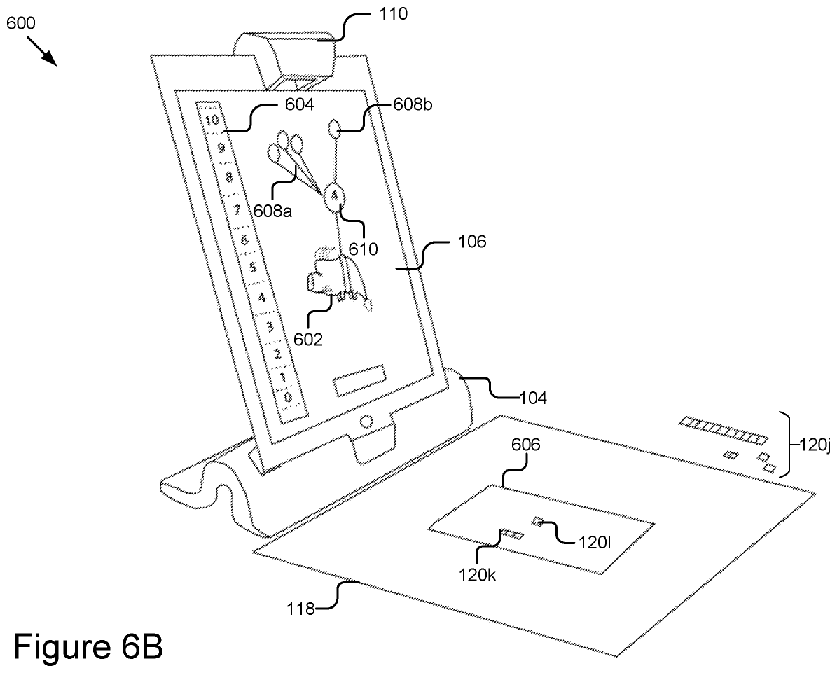

FIGS. 6A and 6B depict an example configuration 600 for detection and virtualization of tangible object quantities. As shown in this example configuration 600, the physical activity surface 118 includes a play area with an input area 606 on which tangible interface objects 120 can be placed. In this example, the input area 606 is represented by rectangular area, but other shapes and configurations of the input area 606 are also contemplated. In some implementations, the input area 606 is used to speed up the processing time of the detector 304 by only analyzing the portions of the video stream that include the input area 606 to detect tangible interface objects 120. In some implementations, an input area 606 is not present and tangible interface objects 120 can be placed anywhere within the field of view of the video capture device. The input area 606 is where tangible interface objects representing a quantity may be placed and detected by the detector 304.

As shown in FIG. 6A, the virtual scene 106 may include both a quantity indicator 604 and/or a virtual character 602. The quantity indicator 604 may represent value determined based on the quantity represented by the tangible interface objects 120. In this example, the quantity indicator 604 is a bar along the side of the display screen that depicts various values that increase heading towards the top of the screen. In the example shown, the virtual character 602 is being lifted by balloons representing the quantity of tangible interface objects 120 positioned in the input area 606. As shown, the tangible interface objects 120j are positioned outside of the input area 606, so the detected quantity is zero and the virtual character 602 is shown at the zero level on the quantity indicator 604 in the virtual scene 106.

As shown in FIG. 6B, tangible interface objects 120k and 120l are positioned within the input area 606 and detected by the detector 304. In this example, the tangible interface object 120k is a rod with three square markings denoting a value of three and the tangible interface object 120l is a single cube with a single square marking denoting a value of one. It should be understood that while rods and cubes are used in this example, other variations of visual markings can be used on a variety of tangible interface objects 120 in order to denote various quantities. As shown, the tangible interface object 120k and the tangible interface object 120l form a group of tangible interface objects that represent a combined quantity of four. In the virtual scene 106, the virtual character 602 is shown being lifted up by four balloons representing the detected quantity. Additionally, in the example, the virtual scene includes two separate virtual quantity groups 608a and 608b that correspond to the detected tangible interface objects 120k and 120l, as well as the detected quantity of each of the tangible interface objects 120k and 120. As shown in the example, the virtual quantity group 608a includes three virtual balloons that correspond to the rod with the represented quantity of three (tangible interface object 120k) and the virtual quantity group 608b includes one virtual balloon that corresponds to the cube with the represented quantity of one (tangible interface object 120l).

In some implementations, the virtual scene 106 may also include a total quantity value 610 that signals the combined quantity of the group of tangible interface objects 120 in the input area 606. As shown, the total quantity value 610 is “four” based on the tangible interface objects 120k and 120l. Additionally, in some implementations, the virtual character 602 may be shown to float into the air in the virtual scene 106 based and represent the value of the combined quantity using the quantity indicator 604. In some implementations, the quantity indicator may display a target quantity value instead of the combined quantity of the group of tangible interface objects 120 in order to signal to a user a desired quantity for the user to form using the tangible interface objects 120. By using the virtual scene 106 to display a routine or animation that reflects the current value of the group of tangible interface objects 120, the user is able to interact with the virtual scene in substantially real-time and learn how various quantities can be combined and change as various tangible interface objects 120 are placed on the input area 606.

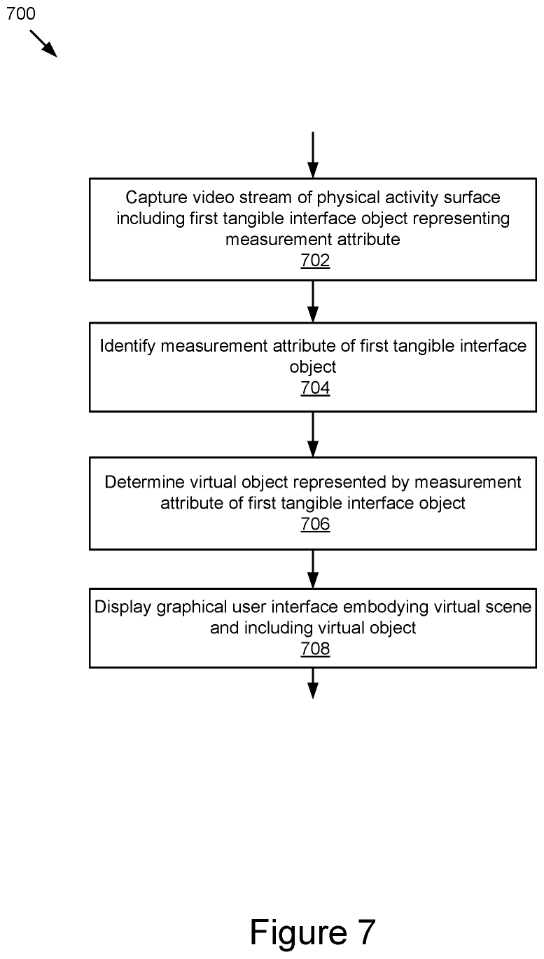

FIG. 7 is a flowchart 700 for detection and virtualization of tangible object dimensions. At 702, the video capture device 206 captures a video stream of a physical activity surface 118 that includes a tangible interface object 120 representing a measurement attribute, such as a specific dimensional length. As described elsewhere herein, the specific dimensional length may be represented by one or more visual elements displayed on the surface of the tangible interface object 120. In further implementations, the detector may be configured to compare the length of the tangible interface object 120 to other objects present on the physical activity scene or to known objects from storage 310 in order to infer a specific dimensional length of the tangible interface object 120. At 704, the detector 304 may identify the specific dimensional length of the tangible interface object 120. In some implementations, the detector 304 may identify the specific dimensional length by matching one or more of the detected visual elements to a database of visual elements and identify a match that exceeds a match threshold.

At 706, the activity application(s) 214 may determine a virtual object represented by the specific dimensional length of the first tangible interface object 120 by comparing the identity of the specific dimensional length to a database of virtual objects and determining a match based on the identity of the specific dimensional length. For example, in some implementations, the specific dimensional length may be associated with a tangible interface object 120 that represents a piece of food for a virtual routine where a dragon is being fed. The virtual object may be a virtualization of the piece of food represented by the tangible interface object 120, such as a hamburger. At 708, the activity application(s) 214 may cause a graphical user interface to be displayed that embodies a virtual scene and includes the virtual object. As discussed in the above example, if the virtual object is a virtual hamburger, the virtual scene may include feeding the virtual hamburger to a virtual character 108, such as a dragon.

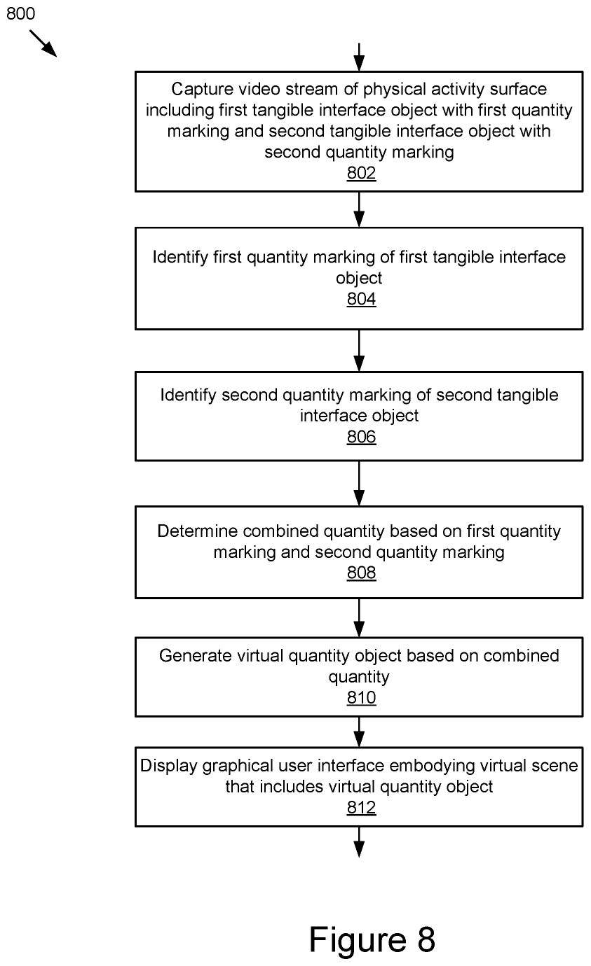

FIG. 8 is a flowchart detection and virtualization of tangible object quantities. At 802, the video capture device 206 captures a video stream of a physical activity surface 118 that includes a first tangible interface object 120 with a first quantity marking and a second tangible interface object 120 with a second quantity marking. As described elsewhere herein, the quantity markings may be visible elements on the tangible interface objects 120, such as squares on rods and/or cubes, etc. At 804, the detector 304 may identify the first quantity marking of the first tangible interface object 120 and at 806, the detector 304 may identify the second quantity marking of the second tangible interface object 120. As described elsewhere herein, the detector 304 may identify the quantity markings by comparing the visual elements of the tangible interface object 120 with a database of quantity markings to identify quantity values that match the quantity markings above a threshold degree of accuracy.

At 808, the activity application(s) 214 may determine a combined quantity based on the first quantity marking and the second quantity marking. It should be understood that while two quantity markings are described herein, any number of quantity markings can be combined after identified by the detector 304. The activity application(s) 214 can combine the quantity markings of each of the tangible interface objects 120. In some implementations, the activity application(s) 214 can identify different groups of combined quantities based on different input areas 502 and can separately group each of the quantities for the different input areas 502. At 810, the activity application(s) 214 can generate a virtual quantity object based on the combined quantity. For example, if the combined quantity is a value of four, the virtual quantity object can be a depiction of the value “4”. In further examples, the activity application(s) 214 may determine a type of the quantity and generate a quantity of virtual objects based on the type for the input area 502 and the type indicator 506. At 812, the activity application(s) 214 may cause a graphical user interface on the display screen to present a virtual scene that includes the virtual quantity object. In some implementations, the virtual scene may include virtual characters that interact with the virtual quantity object and the virtual scene may change based on the value of the virtual quantity object, as described elsewhere herein.

In some implementations, the different applications include a visual map product or other image that is used to unlock the digital aspects of the applications, rather than inputting specific unlock codes when the physical game is purchased. For example, the map product or other image that comes with the product may include one or more visual indicators to indicate which type of product the image is associated with and the software can unlock the digital aspects of the application based on which objects are detected in the image. In some implementations, additional aspects of the applications may have the user place the map in front of the computing device 102 within a field of view of the camera 206 and provide prompts for the user to locate different images on the visual map and detect an interaction, such as a user's finger pointing to the different images. The launcher downloads the entire asset bundle and then unlocks the specific portions of the assets based on which visual map products have been displayed and unlocked.

In another implementation, the activity application 214 may have an application that includes a digital interaction. In this example implementation, a user may be playing head to head against another user or a computer. Mathematical questions are determined by the activity application 214 and scroll out from a side of the screen to be displayed to the players. The user may then drag on the display screen a card up to the mathematical question and place the card in the question. In further implementations, the user may place a card as a tangible interface object 120 on the physical activity surface 118, rather than playing with virtual cards. The cards represent various numbers that satisfies the questions or problems that are coming up. If the card satisfies the mathematical question than the user scores a point or receives another reward in the game. The mathematical questions may be math problems such as “2+2=” or comparisons such as “_>5”. The mathematical questions are dynamically determined by activity application 214 based on how the user is interacting with questions. The cards displayed are determined to be solutions to the mathematical questions, rather than just random numbers that may or may not satisfy the questions. The artificial intelligence of the computer player may be tuned to a specific user as they play based on the speed and correctness of the user as they play. As the user improves in speed or accuracy, the computer will either increase and/or decrease their performance to make it completive. In some implementations, the computer intelligence can be stored and associated with specific users to increase the user engagement and provide a challenge that pushes a user without frustrating them. In further implementations, the mathematical questions may be tuned based on the specific needs or activities that the user needs to be taught. A user may be identified, such as by using a camera recognizing a user and/or a user profile login. The activity application 214 may identify where the user, such as a child, is in the learning applications and then curate specific personalized mathematical questions based on the needs identified for the user.

In another implementation, the activity application 214 may display a virtual character and may request from the user a prompt of a specific input quantity of tangible interface objects 120 for the user to place in the physical activity surface 118. The user may place one or more tangible interface objects 120 onto the physical activity surface 118 and the detection engine 212 may update the quantity based on the placed tangible interface objects 120 and the virtual scene may be updated based on that quantity. In a specific example, the virtual character may be floating on a quantity of balloons and the virtual character may have a specific weight value, such as a ten value for weight. As the user places rods and cubes representing quantities, the quantity of balloons is updated on the screen. When the quantity of rods and cubes exceeds the weight value, then the virtual character may float up. In some implementations, the detection engine 212 may be able to detect a portion of the rods and cubes and infer the quantity of rods and cubes even if the rods and cubes are obscured by a user's hand as the rods and cubes are placed.

In another implementation, the activity application 214 may display a column building game where columns with specific quantities of blocks move down from a side of the display screen (such as a top of the display screen). The user may manipulate where the column may be placed as the columns move down the screen towards the opposite side (such as a bottom of the screen). When the column is placed on other side of the screen, it builds up with previous quantities of columns to reflect the new values. For example, if a portion of the side already has a quantity of three and the new column has a quantity of six, when the new column is placed on top of the old column, the new value of the column is nine. In some implementations, each of the column clusters have a different color and when the column cluster is merged with other columns, each of the columns retains the previous column color as it merges into the new column value. In the building game, when a column merges and exceeds a specific value threshold, such as a ten value, the portion of the column that exceeds that threshold is removed and the user scores points. For example, when a new column with a value of five merges with the column that had a previous value of nine, the new column value is fourteen and the column exceeds the ten-value threshold. The merged column may then remove a quantity of ten blocks from the merged column and keep the remaining blocks in the column. In further implementations, when the merged column removes the portion of the blocks, if the last block to be removed (e.g., the tenth block down when the threshold is reached) is part of a previous block section (such as a color section from a previous block where if the last block is removed, a remaining color portion would remain behind) then the entire previous block section is also removed. For example, using the previous five block and nine block above, when the five block merges with the nine block it exceeds the ten value threshold, so the five block and five of the nine blocks are removed for the quantity of ten, however, the remaining portions of the nine block are also removed (e.g., the remaining four of the nine blocks) and added to the calculated score.

This technology yields numerous advantages including, but not limited to, providing a low-cost alternative for developing a nearly limitless range of applications that blend both physical and digital mediums by reusing existing hardware (e.g., camera) and leveraging novel lightweight detection and recognition algorithms, having low implementation costs, being compatible with existing computing device hardware, operating in real-time to provide for a rich, real-time virtual experience, processing numerous (e.g., >15, >25, >35, etc.) tangible interface object(s) 120 and/or an interaction simultaneously without overwhelming the computing device, recognizing tangible interface object(s) 120 and/or an interaction (e.g., such as a wand 128 interacting with the physical activity scene 116) with substantially perfect recall and precision (e.g., 99% and 99.5%, respectively), being capable of adapting to lighting changes and wear and imperfections in tangible interface object(s) 120, providing a collaborative tangible experience between users in disparate locations, being intuitive to setup and use even for young users (e.g., 3+ years old), being natural and intuitive to use, and requiring few or no constraints on the types of tangible interface object(s) 120 that can be processed.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi′) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
displaying, on a display of a computing device, a graphical user interface embodying a virtual scene, the virtual scene including a virtual prompt representing a virtual dimension;
capturing, using a video capture device associated with the computing device, a video stream of a physical activity scene, the video stream including a first tangible interface object representing a first measurement attribute and a second tangible interface object representing a second measurement attribute;
identifying, using a processor of the computing device, the first measurement attribute of the first tangible interface object;
identifying, using the processor of the computing device, the second measurement attribute of the second tangible interface object;
determining, using the processor of the computing device, a combined measurement attribute based on the first measurement attribute and the second measurement attribute;
comparing, using the processor of the computing device, the combined measurement attribute with the virtual dimension; and
displaying, on a display of the computing device, a graphical user interface embodying a virtual scene, the virtual scene including a status indicator based on the comparison between the combined measurement attribute and the virtual dimension.

2. The method of claim 1, wherein the first measurement attribute is identified by detecting a first dimensional marking on the first tangible interface object and the second measurement attribute is identified by detecting a second dimensional marking on the second tangible interface object.

3. The method of claim 1, wherein the comparison between the combined measurement attribute and the virtual dimension is one of the combined measurement attribute being greater than the virtual dimension, the combined measurement attribute being less than the virtual dimension, and the combined measurement attribute being equivalent to the virtual dimension.

4. The method of claim 1, wherein the first measurement attribute is a first dimensional length of the first tangible interface object and the second measurement attribute is a second dimensional length of the second tangible interface object.

5. The method of claim 1, wherein the virtual dimension is based on a physical character measurement attribute of a physical character in the physical activity scene.

6. A method comprising:
capturing, using a video capture device associated with a computing device, a video stream of a physical activity scene, the video stream including a first tangible interface object representing a measurement attribute;
identifying, using a processor of the computing device, the measurement attribute of the first tangible interface object;
determining, using the processor of the computing device, a virtual object represented by the measurement attribute of the first tangible interface object; and
displaying, on a display of the computing device, a graphical user interface embodying a virtual scene, the virtual scene including the virtual object.

7. The method of claim 6, wherein the first tangible interface object includes one or more visual elements displayed on a surface of the first tangible interface object, the one or more visual elements being detectable by the processor of the computing device.

8. The method of claim 7, wherein the one or more visual elements of the first tangible interface object includes a dimensional marking.

9. The method of claim 6, wherein the video stream further includes a physical character in the physical activity scene, the physical character having a physical character attribute, the method further comprising:
comparing the measurement attribute of the first tangible interface object with the physical character attribute; and
responsive to determining that the measurement attribute of the first tangible interface object is equivalent to the physical character attribute, updating on the display of the computing device, the virtual scene to include a status update indicating that the measurement attribute of the first tangible interface object is equivalent to the physical character attribute.

10. The method of claim 6, further comprising:
displaying, on the display of the computing device, a virtual prompt representing a virtual measurement attribute; and
comparing the measurement attribute of the first tangible interface object to the virtual measurement attribute.

11. The method of claim 10, further comprising:
responsive to the comparison indicating that the measurement attribute of the first tangible interface object is equivalent to the virtual measurement attribute, executing a virtual routine in the virtual scene indicating that the comparison was correct.

12. The method of claim 10, further comprising:
responsive to the comparison indicating that the measurement attribute of the first tangible interface object is not equivalent to the virtual measurement attribute, executing a virtual routine in the virtual scene indicating that the comparison was incorrect.

13. The method of claim 6, wherein, the video stream is a first video stream, and the measurement attribute is a first measurement attribute, the method further comprising:
capturing, using the video capture device associated with the computing device, a second video stream of the physical activity scene, the second video stream including the first tangible interface object representing the first measurement attribute and a second tangible interface object representing a second measurement attribute;
identifying, using the processor of the computing device, the second measurement attribute of the second tangible interface object;
grouping, using the processor of the computing device, the first measurement attribute with the second measurement attribute to determine a combined measurement attribute of the first tangible interface object and the second tangible interface object; and
comparing the combined measurement attribute with a virtual dimension to determine if the combined measurement attribute is equivalent to the virtual dimension.

14. A physical activity visualization system comprising:
a video capture device coupled for communication with a computing device, the video capture device being adapted to capture a video stream that includes a first tangible interface object representing a measurement attribute;
a detector coupled to the computing device, the detector being adapted to identify within the video stream the measurement attribute of the first tangible interface object;
a processor of the computing device, the processor being adapted to determine a virtual object represented by the measurement attribute of the first tangible interface object; and
a display coupled to the computing device, the display being adapted to display a graphical user interface embodying a virtual scene, the virtual scene including the virtual object.

15. The physical activity visualization system of claim 14, wherein the first tangible interface object includes one or more visual elements displayed on a surface of the first tangible interface object, the one or more visual elements being detectable by the processor of the computing device.

16. The physical activity visualization system of claim 15, wherein the one or more visual elements of the first tangible interface object includes a dimensional marking.

17. The physical activity visualization system of claim 15, wherein the video stream further includes a physical character, the physical character having a physical character attribute, and the processor being further adapted to compare the measurement attribute of the first tangible interface object with the physical character attribute, and responsive to determining that the measurement attribute of the first tangible interface object is equal to the physical character attribute, update on the display of the computing device, the virtual scene to include a status update indicating that the measurement attribute of the first tangible interface object is equivalent to the physical character attribute.

18. The physical activity visualization system of claim 14, wherein the display is further adapted to display a virtual prompt representing a virtual dimension and the processor is further adapted to compare the measurement attribute of the first tangible interface object to the virtual dimension.

19. The physical activity visualization system of claim 18, wherein, responsive to the comparison indicating that the measurement attribute of the first tangible interface object is equivalent to the virtual dimension, causing the processor to execute a virtual routine in the virtual scene indicating that the comparison was correct.

20. The physical activity visualization system of claim 18, wherein, responsive to the comparison indicating that the measurement attribute of the first tangible interface object is not equivalent to the virtual dimension, causing the processor to execute a virtual routine in the virtual scene indicating that the comparison was incorrect.

21. The physical activity visualization system of claim 14, wherein, the video stream is a first video stream and the measurement attributes a first measurement attribute, and wherein,
the video capture device is further adapted to capture a second video stream, the second video stream including the first tangible interface object representing the first measurement attribute and a second tangible interface object representing a second measurement attribute; and
the processor if further adapted to identify the second measurement attribute of the second tangible interface object, group the first measurement attribute with the second measurement attribute to determine a combined measurement attribute of the first tangible interface object and the second tangible interface object, and compare the combined measurement attribute with a virtual dimension to determine if the combined measurement attribute is equal to the virtual dimension.

22. A method comprising:
capturing, using a video capture device associated with a computing device, a video stream of a physical activity scene, the video stream including a first tangible interface object with a first quantity attribute marking and a second tangible interface object with a second quantity attribute marking;
identifying, using a processor of the computing device, the first quantity attribute marking of the first tangible interface object;
identifying, using a processor of the computing device, the second quantity attribute marking of the second tangible interface object;
determining, using the processor of the computing device, a combined quantity based on the first quantity attribute marking and the second quantity attribute marking;
generating, using the processor of the computing device, a virtual quantity object based on the combined quantity; and
displaying, on a display of the computing device, a graphical user interface embodying a virtual scene, the virtual scene including the virtual quantity object.

23. The method of claim 22, wherein the first tangible interface object is a cube and the first quantity attribute marking is a rectangular square visible on the cube.

24. The method of claim 22, wherein the second tangible interface object is a rod and the second quantity attribute marking is a plurality of rectangular square visible on the rod.
